(19) United States
(12) Patent Application Publication
(10) Pub. No.: US 2007/0189728 A1
(43) Pub. Date: Aug. 16, 2007

(54) Method of recording and reproducing surveillance images in DVR

(75) Inventor: Sung Hun Yu, Seoul (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/643,651

(22) Filed: Dec. 22, 2006

(30) Foreign Application Priority Data
Dec. 22, 2005 (KR) 10-2005-0128069

(51) Int. Cl. H04N 5/91

(52) U.S. Cl. 386/107

(57) ABSTRACT

Disclosed herein is a method of recording and reproducing surveillance images in a Digital Video Recorder (DVR). In one embodiment of the present invention, a recording speed such as a frame rate for surveillance images are controlled according to extent of motion of subjects in the surveillance detected through prediction between neighboring frames, and information about the controlled frame rates and information about time at which the frame rate is used may be managed and recorded in an associated manner. In another embodiment of the present invention, based on information about frame rates managed in associated with information about time at which the frame rate is used, specific frames from surveillance images on a recording medium are selectively reproduced, and a period in which frames are recorded at a frame rate higher than a specific rate may be selected and reproduced.

### BACKGROUND OF THE INVENTION

1. Field of the Invention

The present invention relates generally to a method of recording and reproducing surveillance images in a Digital Video Recorder (DVR) and, more particularly, to a method of recording and reproducing surveillance images at varying frame rates.

2. Description of the Related Art

Recently, as Digital Video Recorders (DVRs) have been widely commercialized, surveillance cameras are installed in places requiring security in order to capture surveillance images and store the captured images.

For example, as illustrated in FIG. 1, a surveillance camera 100 captures images of a subject in a specific area and outputs the captured images to a DVR 200 in a remote place. The DVR 200 displays the surveillance images captured by the surveillance camera 100 on a monitor, and also records them in a storage medium, such as a hard disk or an optical disk, included therein.

In general, a DVR has a motion event function of either not recording surveillance images or recording them at a minimal frame rate when there is no change in the subject in the surveillance images, and recording surveillance images in a storage medium or issuing a warning only when there are changes in the subject in the surveillance images. The reason for this is to efficiently utilize the storage medium and to enable the operator of the DVR to quickly and conveniently search past surveillance images.

When a motion event mode is set, the DVR 200 compares neighboring frames of a sequence of frames of surveillance images, which are received from the surveillance camera 100 and captured, with each other, and detects the motion of a subject in the surveillance images.

At this time, the DVR 200 detects the motion vector of the moving subject (information including the direction and extent of the motion of the subject in a neighboring frame and a current frame) through inter-frame prediction, which is also used in image compression.

If the detected motion vector exceeds a preset reference value, that is, if the motion of the subject is significant, the DVR 200 records a sequence of frames of surveillance images, received from a corresponding time point, in the storage medium.

As a result, the operator can monitor a corresponding area in real time while viewing the surveillance images displayed on the screen of the monitor, or can detect an emergency situation that previously occurred in the corresponding area by reproducing the surveillance images stored in the storage medium.

When a motion event occurs, a typical DVR captures frames of surveillance images at a preset frame rate. If the frame rate is set to an excessively high value, the surveillance images may not be recorded due to a shortage of the redundant capacity of a storage medium. However, if the frame rate is set to an excessively low value, the ability to distinguish between surveillance images may be degraded.

### SUMMARY OF THE INVENTION

Accordingly, the present invention has been made keeping in mind the above problems occurring in the prior art, and an object of the present invention is to provide a method of controlling frame rate when surveillance images are recorded.

Another object of the present invention is to provide a method of efficiently reproducing surveillance images recorded at varying frame rates.

In order to accomplish the above objects, the present invention provides a method of recording surveillance images in a DVR, including the steps of detecting the extent of the motion of one or more subjects in the surveillance images; and controlling a recording speed for the surveillance images according to the detected extent of the motion.

In an embodiment, the extent of the motion of the subjects may be detected through prediction between neighboring frames.

In a further embodiment, the recording speed for the surveillance images may be controlled in proportion to the sizes of motion vectors and/or the number of motion vectors.

In another embodiment, the shutter speed of a surveillance camera may be controlled according to the detected extent of the motion, and the sensitivity of CCD or the iris of the surveillance camera may be controlled according to the shutter speed.

In another embodiment, information about the recording speed and information about a time at which the recording speed is used may be managed in an associated manner, and the information about the recording speed may be frame rate or an interval between frames. In this case, the time information is recorded on each frame of the surveillance images, and the information in which the recording speed information is associated with the time information is recorded in a separate file on a recording medium in which the surveillance images are recorded.

In order to accomplish the above objects, the present invention provides a method of reproducing surveillance images in a DVR, including the steps of checking information about a recording speed for the surveillance images; and selecting specific frames from the surveillance images recorded on a recording medium, based on the checked information, and reproducing the selected frames.

In an embodiment, frames of the surveillance images recorded on the recording medium may include time information, and the information about the recording speed may be recorded in association with the time information for frames recorded at the recording speed on the recording medium in a separate file. In this case, the recording speed is frame rate or an interval between frames.

In an embodiment, a period in which frames are recorded at a recording speed higher than a specific recording speed may be selected and the frames included in the period may be reproduced, based on the information about the recording speed which is recorded in association with the time information.

Furthermore, a period in which frames are recorded at a recording speed higher than a specific recording speed for longer than a predetermined period may be selected and the frames included in the period may be reproduced, based on the information about the recording speed which is recorded in association with the time information.

In an embodiment, the selected frames may be reproduced at a frame rate at which the frames were recorded.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view illustrating an example in which a typical surveillance camera and a typical DVR are connected to each other;

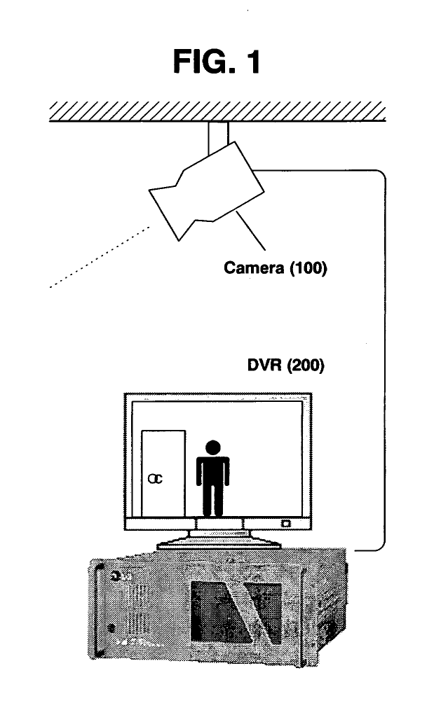

FIG. 2 is a block diagram showing the construction of a DVR to which the present invention can be applied;

FIG. 3 is a diagram illustrating an embodiment in which frames are recorded at various frame rates, and an embodiment in which frame rate and application time are managed in an associated manner;

FIG. 4 is a flowchart illustrating a method of recording surveillance images in a DVR according to an embodiment of the present invention; and

FIG. 5 is a flowchart illustrating a method of reproducing surveillance images in a DVR according to an embodiment of the present invention.

### DETAILED DESCRIPTION OF PREFERRED EMBODIMENTS

A method of recording and reproducing surveillance images in a DVR according to the present invention will now be described in detail in conjunction with preferred embodiments with reference to the accompanying drawings.

When a motion event mode is set, a conventional DVR monitors the motion of a subject in surveillance images, and either does not record the surveillance images (or records them at a minimal frame rate) or records the surveillance images at a preset frame rate, depending on the size of a motion vector corresponding to the motion.

The monitoring of the motion of the subject is performed through inter-frame prediction, which is also used in image compression. In this case, motion information between two image frames, that is, information about the moving direction of a moving subject, the size of displacement, the number of moving subjects, etc. between two frames, is obtained.

Since such motion information is continuously detected in the motion event mode, it can be efficiently used to control the rate at which surveillance images are recorded, that is, the recording frame rate.

Accordingly, in the present invention, the rate at which surveillance images are recorded, that is, the recording frame rate, is controlled using information about the size of a motion vector (the extent of motion), which is continuously detected in a motion event mode, and/or the number of subjects performing motion, the extent of which is greater than a preset value, in one surveillance image.

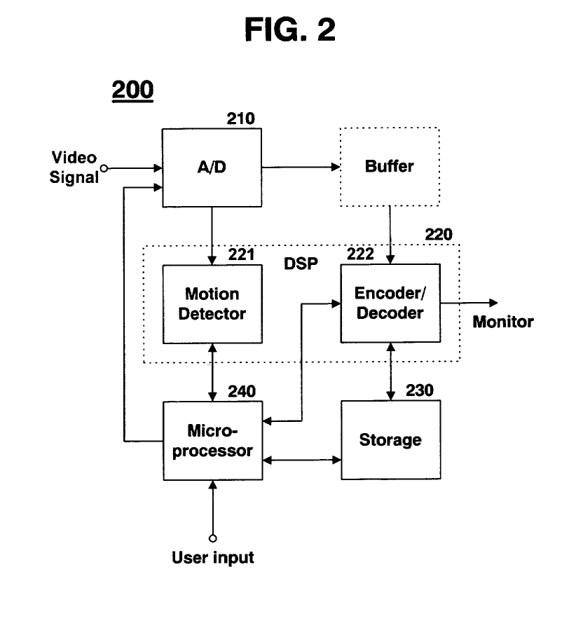

FIG. 2 is a block diagram showing the construction of a DVR to which the method of recording and reproducing surveillance images according to an embodiment of the present invention can be applied.

The DVR 200 may include an Analog/Digital (A/D) converter 210, a Digital Signal Processor (DSP) 220, storage 230 and a microprocessor 240.

The A/D converter 210 converts analog video signals, received from the Charge-Coupled Device (CCD) of the surveillance camera 100, into digital image data. The storage 230 stores data encoded by the DSP 220. A high-capacity recording medium, such as a hard disk or an optical disk, may be used as the storage 230.

The DSP 220 converts the digital data of the surveillance images into image frames and outputs the image frames to an external display device, such as a monitor. The DSP 220 encodes the digital image data in order to record it in the storage 230, or decodes data recorded in the storage 230. Furthermore, the DSP 220 detects the motion of a moving subject from the digital image data, informs the microprocessor 240 of the occurrence of a motion event, and transmits motion information.

The DSP 220 may be divided into a motion detector 221 capable of detecting the motion of subjects and an encoder/decoder 222 responsible for the conversion, encoding and decoding of data. Even when the DSP 220 is divided into the motion detector 221 and the encoder/decoder 222, the inter-frame prediction can be used formation detection and the encoding/decoding of data in the same manner and, therefore, a process related to inter-frame prediction can be shared.

The motion detector 221 constructs an image frame based on the digital image data, and compares the constructed image frame with the previous frame to detect information about the motion vectors of subjects in the frame. If, as a result of the comparison, the size of at least one motion vector is greater than a first reference value, the motion detector 221 generates a signal indicating the occurrence of a motion event and outputs the signal to the microprocessor 240. The motion detector 221 calculates the extent of motion and the number of moving subjects based on the detected motion vector information, and outputs information about the calculated extent and number.

If information about the occurrence of a motion event is not received from the motion detector 221, the microprocessor 240 controls the encoder/decoder 222 so that surveillance images are not recorded, or are encoded at a minimal recording frame rate (for example, a frame rate of six frames per second).

However, if information about the occurrence of a motion event and motion information are received from the motion detector 221, the microprocessor 240 determines the rate at which surveillance images are recorded (that is, the recording frame rate) based on the motion information (that is, the extent of motion and/or the number of moving subjects), and provides information about the recording frame rate to the encoder/decoder 222 so that the surveillance images can be recorded in the storage 230 at the determined recording frame rate.

The microprocessor 240 may set the recording frame rate to a high value for the surveillance images, including a subject performing relatively significant motion or a large number of moving subjects, or may set the recording frame rate to a low value for the surveillance images, including a subject performing relatively insignificant motion or a small number of moving subjects, based on the information about the extent of motion and the number of moving subjects received from the motion detector 221.

For example, if insignificant motion is detected while digital image data is received through the A/D converter 210 at a rate of 30 frames per second, the recording frame rate may be adjusted to a lower value, for example, 10 frames per second. In contrast, if significant motion is detected, the recording frame rate is adjusted to a high value, for example, 30 frames per second.

The encoder/decoder 222 encodes the digital image data according to information about the recording frame rate received from the microprocessor 240, and records the encoded data in the storage 230.

In detail, the encoder/decoder 222 constructs a sequence of image frames from the digital image data at time intervals corresponding to the recording frame rate, and encodes the constructed sequence of image frames. In this case, the constructed sequence of image frames may be encoded using an image compression scheme such as inter-frame prediction.

For example, in the case where digital image data is input through the A/D converter 210 at a rate of 30 frames per second and the recording frame rate is set to a rate of 15 frames per second, the encoder/decoder 222 extracts only one image frame from image data composed of two successive frames, constructs a sequence of image frames corresponding to a rate of 15 frames per second, and encodes the constructed sequence of image frames.

If the detected extent of the motion of a subject is greater than a second preset reference value, the microprocessor 26 may increase the shutter speed of a surveillance camera, for example, from 1/60 second to 1/120 second, so that images of a significantly moving subject can be normally captured. In this case, the microprocessor 26 may control the iris of a lens in order to obtain the necessary amount of light, or may control a surveillance camera in order to increase the sensitivity of a CCD.

Meanwhile, there may be a time interval between the image frame used to determine the recording frame rate (that is, the image frame used to calculate the motion vectors) and the image frame recorded at the determined recording frame rate.

That is, the determined recording frame rate is applied to an image frame subsequent to the image frame, which is used to determine the recording frame rate, due to the calculation of the motion vectors and the calculation of the extent of motion and the number of moving subjects in the motion detector 221, the determination of the recording frame rate in the microprocessor 240, the standby time for the application of the recording frame rate in the encoder/decoder 222, etc.

In general, the time interval is so insignificant that it can be ignored. However, if necessary, a buffer for temporarily storing digital image data output from the A/D converter 210 may be disposed between the A/D converter 210 and the DSP 220 in order to eliminate the time interval.

In this case, the motion detector 221 provides information about corresponding image frame (for example, time information about an image frame), along with information about the occurrence of a motion event and motion information, to the microprocessor 240, and the microprocessor 240 also provides information about the determined recording frame rate, along with the information about the corresponding image frame, to the encoder/decoder 222.

The encoder/decoder 222 sequentially constructs image frames from image frames corresponding to the time information, which, along with the recording frame rate information, is provided by the microprocessor 240, at intervals corresponding to the recording frame rate based on the digital image data stored in the buffer, and encodes the constructed image frames.

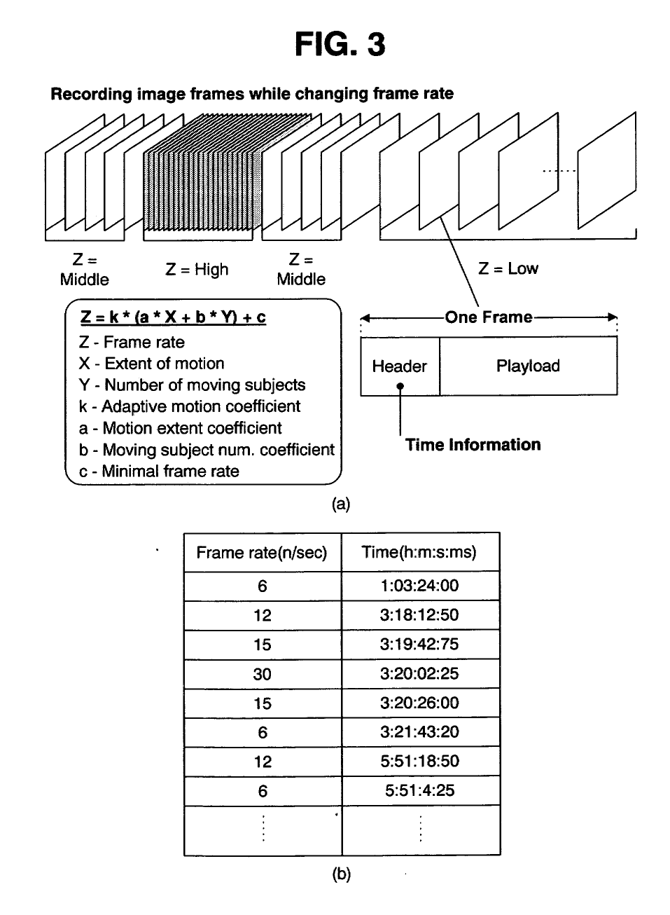

The microprocessor 240 records a system time, which is kept inside the DVR 200, as the recorded time of an image frame in connection with the image frame when recording the image frame, encoded by the encoder/decoder 222, in the storage 230. The microprocessor 240 may record the system time in the header of each image frame, as illustrated in FIG. 3(a).

The microprocessor 240 associates information about the frame rate, or the time interval between frames, with information about the recorded time of an image frame to which the frame rate is first applied, and manages them as separate data in order to indicate the image frame to which the determined recording frame rate is first applied, and records them in the storage 230 or in separate non-volatile memory, as illustrated in FIG. 3(b).

Since the data in which the information about the frame rate (or the frame interval) is associated with the information about the recorded time is continuously updated, it can be recorded in the storage 230 in a separate file at specific time intervals (for example, time intervals of one day or twelve hours).

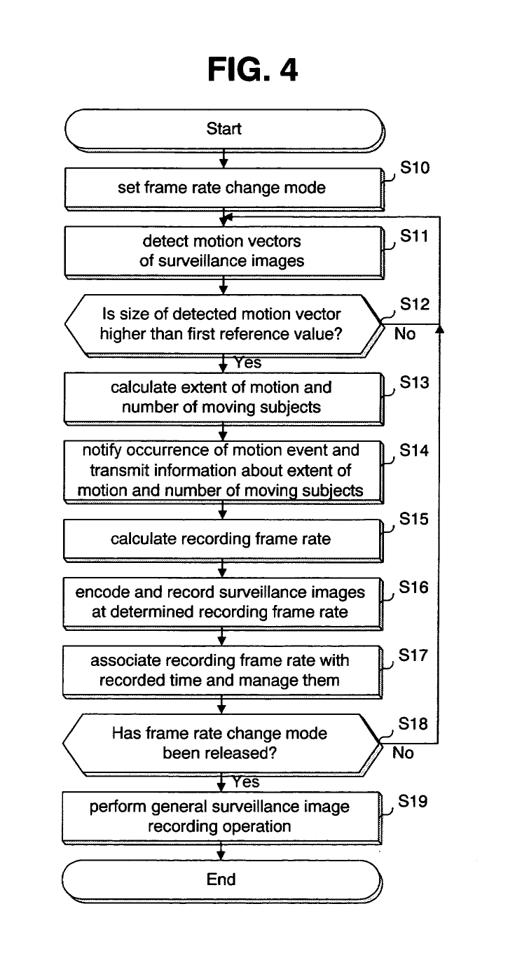

FIG. 4 is a flowchart illustrating a method of recording surveillance images in a DVR according to an embodiment of the present invention.

The microprocessor 240 sets a frame rate change mode at the request of a user at step S10, and controls the operation of the motion detector 221.

The motion detector 221 constructs a surveillance image frame from digital data output from the A/D converter 210, compares the constructed image frame with the previous frame, and detects motion vectors (that is, the motion components of subjects on surveillance images) at step S11.

If the size of at least one detected motion vector is greater than a first preset reference value at step S12, the motion detector 221 analyzes the motion vector in a surveillance image, in which a motion event has occurred, in order to calculate the extent of motion and the number of moving subjects at step S13, generates a detection signal indicating the occurrence of the motion event and outputs the detection signal, along with information about the extent of motion and the number of moving subjects, to the microprocessor 240 at step S14.

The microprocessor 240 calculates recording frame rate proportional to the extent of motion and the number of moving subjects at step S15. For instance, as illustrated in FIG. 3(a), recording frame rate Z may be “Z=k(a*X+b*Y)+c”, where “k” is an adaptive motion coefficient, “a” is a motion extent coefficient, “b” is a moving subject number coefficient, and “c” is minimal frame rate.

The microprocessor 240 controls the encoder/decoder 222, so that the surveillance images are encoded and recorded at the determined recording frame rate at step S16. As illustrated in FIG. 3, the surveillance images are recorded in the storage 230 at varying recording frame rates proportional to the extent of motion and the number of moving subjects.

In other words, encoding and recording operations are performed at a higher frame rate if the extent of motion or the number of moving subjects is greater, at a lower frame rate if the extent of motion or the number of moving subjects is lower, and at an intermediate frame rate when the extent of motion or the number of moving subjects is intermediate. In this case, the sequence of frames of surveillance images may be stored in the storage 230 in a separate file at specific time intervals (for example, intervals of 6 or 12 hours).

As illustrated in FIG. 3, the microprocessor 240 adds recorded time information to the header information of each frame, associates the determined frame rate with the recorded time of an image frame to which the frame rate is first applied, manages them, and records them in memory or the storage 230 at step S17.

If a frame rate change mode is released at step S18, the microprocessor 240 performs a normal surveillance image recording operation at step S19.

As described above, surveillance images of a significantly moving subject are recorded in the storage 230 at a higher frame rate, and surveillance images of an insignificantly moving subject are recorded in the storage 230 at a lower frame rate. Accordingly, a storage medium having limited capacity can be more efficiently used.

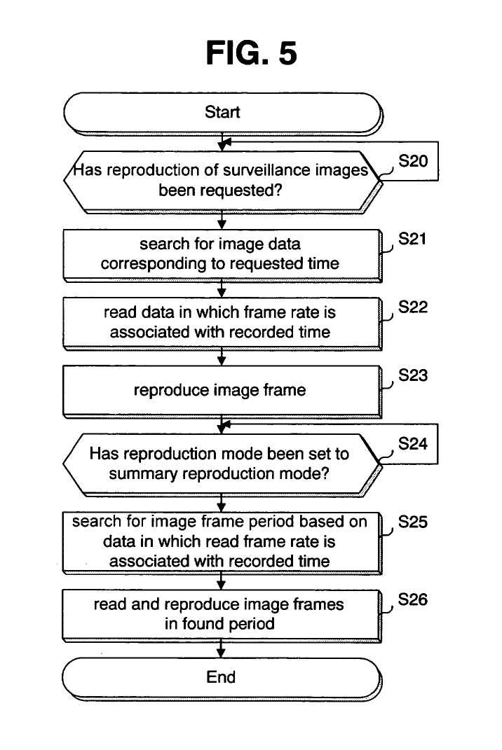

FIG. 5 is a flowchart illustrating a method of reproducing surveillance images in a DVR according to an embodiment of the present invention.

If the reproduction of a surveillance image at a specific time is requested by a user at step S20, the microprocessor 240 searches data, recorded in the storage 230, for the surveillance image corresponding to the requested time at step S21. If surveillance image data has been recorded in files at specific time intervals, the file corresponding to the time requested by the user is opened, and an image frame corresponding to the time requested by the user is identified through the recorded time information included in the header information of each frame.

The microprocessor 240 also searches for and reads the data in which frame rate and recorded time have been associated with each other, which is stored in the memory or storage 230 of the DVR, at step S22.

The microprocessor 240 controls the encoder/decoder 222, so that image frames recorded in the storage 230 are sequentially reproduced from the identified image frame at step S23.

In this case, the recorded time interval between frames may vary according to the recording frame rate applied when the image frames were recorded. The recorded time interval may be changed by the user, if necessary.

The respective image frames may be reproduced at recording frame rates recorded in the headers of the image frames. For example, image frames recorded at a recording frame rate of six frames per second may be reproduced at a rate of six frames per second, and image frames recorded at a recording rate of fifteen frames per second may be reproduced at a rate of fifteen frames per second.

Alternatively, image frames may be reproduced at a constant rate (or a fixed speed) regardless of the recording frame rates recorded in the headers of the image frames. For example, a sequence of image frames in which image frames, recorded at a recording frame rate of six frames per second, and image frames, recorded at a recording frame rate of fifteen frames per second, are mixed with each other may be uniformly reproduced at a rate of fifteen frames per second. In this case, the image frames recorded at a recording frame rate of six frames per second are reproduced more than twice as fast as the image frames recorded at a recording frame rate of fifteen frames per second.

Meanwhile, the microprocessor 240 can selectively reproduce only image frames (that is, only surveillance image frames including significantly moving subjects), recorded at a recording frame rate higher than a specific reference value, using the data in which frame rate and recorded time are associated with each other. This reproduction mode may be referred to as a “summary reproduction mode.”

If the reproduction mode is set to a summary reproduction mode at step S24, the microprocessor 240 searches for a period in which image frames were recorded at a recording frame rate set by the user (or preset) (for example, at a recording frame rate of 15 frames per second), based on the read data in which the frame rate and the recorded time are associated with each other at step S25. In the example of FIG. 3(b), a period in which image frames were recorded at a recording frame rate of 15 frames per second or higher, ranges from 3:19:42:75 to 3:21:43:20.

The microprocessor 240 sequentially reads image frames in a found period from the storage 230, controls the encoder/decoder 222, so that the sequentially read image frames are decoded, and outputs the decoded image frames to the monitor. In this case, the image frames are reproduced at recording frame rates recorded on the headers of the image frames at step S26.

Meanwhile, the microprocessor 240 may selectively reproduce image frames recorded, for longer than a specific time period, at a frame rate higher than a minimal frame rate which is applicable to the case where there is no moving subject in surveillance images. It is therefore possible to reduce the time taken to review surveillance images through the summary reproduction.

For reference, a menu screen for setting a desired reproduction mode or desired reproduction rate may be displayed at the time at which surveillance image data to be reproduced is selected, the time at which a reproduction operation starts, or during a reproduction operation.

Accordingly, according to the present invention, the limited capacity of a storage medium on which surveillance images are stored can be efficiently used, and surveillance images can be efficiently reviewed, therefore surveillance performance can be increased.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of recording surveillance images in a Digital Video Recorder (DVR), comprising the steps of:
detecting extent of motion of one or more subjects in the surveillance images; and
controlling a recording speed for the surveillance images according to the detected extent of motion.

2. The method as set forth in claim 1, wherein the extent of motion of the subjects is detected through prediction between neighboring frames.

3. The method as set forth in claim 2, wherein the recording speed for the surveillance images is controlled in proportion to sizes of motion vectors and/or a number of motion vectors.

4. The method as set forth in claim 1, further comprising the step of controlling a shutter speed of a surveillance camera according to the detected extent of motion.

5. The method as set forth in claim 4, wherein sensitivity of Charge Coupled Device (CCD) or an iris of the surveillance camera is controlled according to the shutter speed.

6. The method as set forth in claim 1, further comprising the step of managing information about the recording speed and information about a time at which the recording speed is used in an associated manner.

7. The method as set forth in claim 6, wherein the information about the recording speed is frame rate or an interval between frames.

8. The method as set forth in claim 6, wherein:
the time information is recorded on each frame of the surveillance images; and
the information in which the recording speed information is associated with the time information is recorded in a separate file on a recording medium in which the surveillance images are recorded.

9. A method of reproducing surveillance images in a DVR, comprising the steps of:
checking information about a recording speed for the surveillance images; and
selecting specific frames from the surveillance images recorded on a recording medium, based on the checked information, and reproducing the selected frames.

10. The method as set forth in claim 9, wherein:
frames of the surveillance images recorded on the recording medium include time information; and
the information about the recording speed is recorded in association with the time information for frames recorded at the recording speed on the recording medium in a separate file.

11. The method as set forth in claim 10, wherein the recording speed is frame rate or an interval between frames.

12. The method as set forth in claim 10, wherein a period in which frames are recorded at a recording speed higher than a specific recording speed is selected and the frames included in the period are reproduced, based on the information about the recording speed which is recorded in association with the time information.

13. The method as set forth in claim 10, wherein a period in which frames are recorded at a recording speed higher than a specific recording speed for longer than a predetermined period is selected and the frames included in the period are reproduced, based on the information about the recording speed which is recorded in association with the time information.

14. The method as set forth in claim 9, wherein the selected frames are reproduced at a frame rate at which the frames were recorded.
